(19) United States
(12) Patent Application Publication
(10) Pub. No.: US 2016/0004783 A1
(43) Pub. Date: Jan. 7, 2016

(54) AUTOMATED GENERATION OF WEB SITE ENTRY PAGES

(71) Applicant: EveryMundo, LLC, Miami, FL (US)

(72) Inventors: Anton Diego, Surfside, FL (US); Seth Cassel, Miami Beach, FL (US); Rene Cairo, Miami, FL (US); Marilyn Rodriguez, Miami, FL (US)

(21) Appl. No.: 14/546,799

(22) Filed: Nov. 18, 2014

Related U.S. Application Data
(60) Provisional application No. 62/019,570, filed on Jul. 1, 2014.

(51) Int. Cl. G06F 17/30; H04L 29/08; G06F 3/0484; G06F 17/21

(52) U.S. Cl. CPC G06F 17/30905; G06F 17/30896; G06F 17/212; G06F 17/30887; H04L 67/02; G06F 3/04842

(57) ABSTRACT

A method on a server for automatically generating a plurality of entry pages for a web site, is disclosed. The method includes receiving a template for generating multiple entry pages, wherein the template includes variables that define the following for a web page: a URL and page content, and receiving values for each variable. The method further includes calculating and storing a definition for each of a plurality of web pages based on the template, wherein a web page is composed of a unique set of values for the variables, and wherein the definition includes a unique URL, and receiving an HTTP request for a web page, wherein the HTTP request includes a unique URL. The method further includes accessing a definition for a web page that corresponds to the unique URL, and generating the web page based on the definition and transmitting the web page.

### CROSS-REFERENCE TO RELATED APPLICATIONS

This patent application claims priority to provisional patent application No. 62/019,570 filed Jul. 1, 2014 and entitled “Automated Generation of Web Site Entry Pages.” The subject matter of provisional patent application No. 62/019,570 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to electronic commerce and, more specifically, to web site content management and search engine optimization.

### BACKGROUND

Enormous amounts of time and resources are expended every year creating and managing content for web sites. In cases involving macro web sites, i.e., very large web sites involving high numbers of web pages and large amounts of web content in multiple languages, the costs of generating and managing content can easily run in the hundreds of thousands, even millions, of dollars. This problem is compounded in situations where a web site's content is constantly changing or growing very rapidly in a global multi-lingual world. A common approach to this problem is the staffing of large numbers of individuals to handle the creation and management of content for macro web sites. One of the drawbacks to the approach, however, involves the time and resources necessary to hire large numbers of people with the requisite skills and the monetary expenditure necessary to maintain a large workforce. Thus, in most cases where a macro web site requires large amounts of content to be generated and managed, it is simply not cost feasible to expend the resources to hire the required number of people. Additionally, this approach is simply not available to smaller business endeavors that do not have the requisite funds.

Likewise, tens of billions of dollars are spent annually on online advertising. As such, the private sector spends a growing amount of time and resources choosing content for a web site in order to improve its visibility to search engines. Visitors to a web page, and subsequent revenues from such visitors, are often determined by the web page's rank in a search engine. Building web pages with a higher position (closer to the top of a search engine result page) is sometimes referred to as search engine optimization (SEO). Such optimization of a web page may involve editing and/or adding relevant content to attract the targeted audience. In order to be effective, a web page's content must be readily comprehensible, as well as relevant to visitors to the web page. Deciding which content to add to a web page, however, can be a difficult and time-consuming task. This problem is compounded in situations where a web site must be optimized for large numbers of different concepts or search terms.

One approach to this problem is to create a separate entry page for each concept or search term that is of interest to the web site owner. In the field of web analytics, an entry page is a web page to which visitors arrive from other another location on the web, such as from a search engine. Entry pages are those pages to which other sites are linking, or those pages that search engines have ranked highly on a particular web site. Thus, on web sites that comprise multiple pages, entry pages are those pages via which visitors enter the web site. One of the drawbacks to the approach of creating a separate entry page for each concept or search, however, is the time and resources necessary to execute the approach. In cases where a web site must be optimized for hundreds or even thousands of concepts or search terms, it is simply not cost feasible to expend the resources to create a separate entry page for each item. Additionally, this approach is simply not available to smaller business endeavors that do not have the funds to execute such a wide-ranging solution.

Therefore, a dire need exists for improvements over the prior art, and more particularly, there is a need for a consolidated method and system for allowing the cost-effective generation and management of large numbers of entry pages for a macro web site.

### SUMMARY

According to the aspects illustrated herein, a method on a server communicatively coupled to a communications network, the method for automatically generating a plurality of entry pages for a web site, is disclosed. The method includes receiving, via the communications network, at least one template for generating multiple entry pages, wherein the at least one template includes a plurality of variables that define the following for a web page: a URL and page content, and receiving, via the communications network, a plurality of values for each of said plurality of variables. The method further includes, for each template of the at least one templates, calculating and storing a definition for each of a plurality of web pages based on said template, wherein a web page is composed of a unique set of values of the plurality of values for the plurality of variables of said template, and wherein the definition includes a unique URL, and receiving, via the communications network, an HTTP request for a particular one of the plurality of web pages, wherein the HTTP request includes a unique URL. The method further includes accessing a definition for a web page of the plurality of web pages that corresponds to the unique URL, and generating the web page based on the definition and transmitting the web page via the communications network.

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

### BRIEF DESCRIPTION OF THE DRAWINGS

The accompanying drawings, which are incorporated in and constitute a part of this disclosure, illustrate various example embodiments. In the drawings:

FIG. 1 is a schematic block diagram of an operating environment of an exemplary disclosed embodiment.

FIG. 2 is a block diagram showing data flow during the process for automatically generating a plurality of entry pages for a web site, according to one embodiment.

FIG. 3 is a flow chart depicting the general control flow of a process for automatically generating a plurality of entry pages for a web site, according to one embodiment.

FIG. 4 is a block diagram of a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

In accordance with the embodiments described herein, the system for automatically generating a plurality of entry pages for a macro web site over a communications network overcomes shortcomings of the prior art by providing a consolidated method and system for allowing the cost-effective generation and management of large numbers of entry pages for a web site. The disclosed embodiments allow a single user devoting a relatively small amount of man-hours to enter data into a computer program that subsequently generates a large number, e.g. thousands or millions, of individual entry pages that are individually optimized for concepts or search terms. Further, the disclosed embodiments allow a user with little or no computer programming or SEO expertise to generate a large number of entry pages using only his knowledge of the concepts or search terms for which his web site must be optimized. Also, the disclosed embodiments allow a user with no proficiency in a second language to generate large numbers of entry pages for his web site in said second language. The end result is that a user with little or no programming or SEO experience and/or little or no experience with a second language can use the disclosed embodiment to seamlessly create and edit a database, including all relationships between data-points within that database.

Lastly, the disclosed embodiments allows for a large number of entry pages to be defined for later recall in real time in a dynamic manner, without requiring that each web page is created and stored on disk, thereby saving storage space.

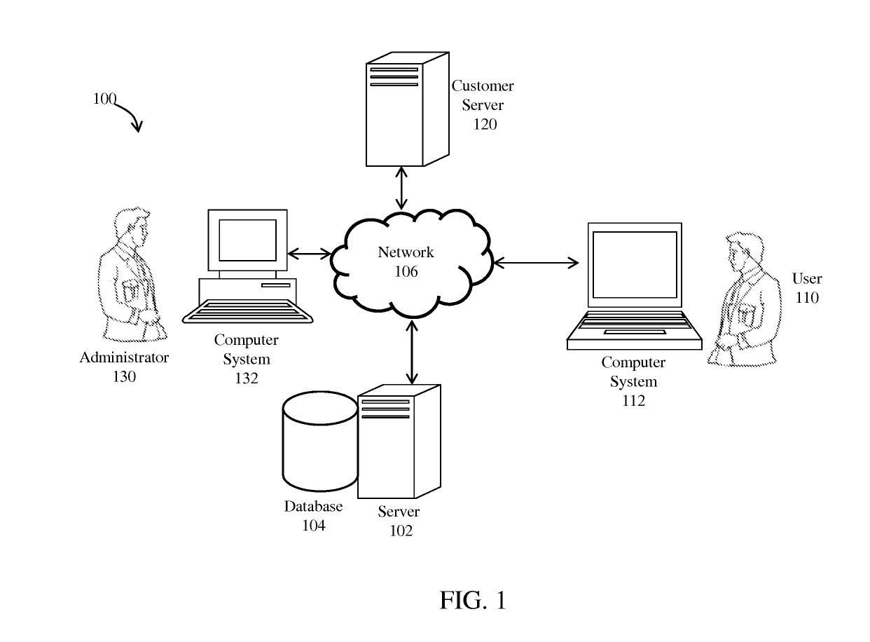

Referring now to the drawing figures in which like reference designators refer to like elements, there is shown in FIG. 1 a block diagram of an operating environment 100 of a system for automatically generating a plurality of entry pages for a web site over a communications network, in accordance to an example embodiment. A prominent element of FIG. 1 is the server 102 associated with a data repository or server-side database 104 and further coupled with network 106, which can be a circuit switched network, such as the Public Service Telephone Network (PSTN), or a packet switched network, such as the Internet or the World Wide Web, the global telephone network, a cellular network, a mobile communications network, a WAN, a LAN, or any combination of the above.

Server 102 collects and manages data from the computer system 132 of administrator 130 and further manages the server-side database 104 modified by the user, which holds data that is served to client computing device 112 on behalf of customer server 120. In one example, server 102 performs the functions of the disclosed embodiment (i.e., automatically generating a plurality of entry pages for a web site) on a contract basis for the web site of the customer server 120. Administrator 130 and associated computer system 132, which input the data needed to generate the entry pages, may either be associated with customer server 120 or server 102. User 110 and associated computer system 112 may be an unrelated third party that simply visits the web site of customer server 120.

FIG. 1 further includes computing devices 120, 112, 102 and 132, which may be a desktop computer, a server, a common computer terminal or mobile computing devices such as smart phones, mobile phones, tablet computers, handheld computers, laptops, any one or more of the above, or the like. The server-side database 104 may, for example, be a relational database comprising a Structured Query Language (SQL) database stored in a SQL server. Server-side database 104 may be distributed over one or more nodes or locations that are connected via network 106.

Server 102 includes a software engine that delivers applications, data, program code and other information to other computing devices, such as device 112, via the network 106. Server 102 thereby includes program logic comprising computer source code, scripting language code (otherwise referred to as a script) or interpreted language code that may be compiled to produce an executable file or computer instructions, or that may be interpreted at run-time, wherein the computer source code performs various functions of the disclosed embodiments. Note that although server 102 is shown as a single and independent entity, in one exemplary embodiment, the functions of server 102 may be integrated with another entity, such as entities 120, 132. Further, server 102 and its functionality, according to a preferred embodiment, can be realized in a centralized fashion in one computer system or in a distributed fashion wherein different elements are spread across several interconnected computer systems.

It should be noted that although FIG. 1 shows only one server 102, one computer system 132, one customer server 120 and one client computing device 112, the system of the disclosed embodiments supports any number of servers, computer systems and client computing devices connected via network 106.

The database 104 is one or more data storage devices for storing templates, variables, values for variables, definitions and the like. As described in further detail below, the database 104 may be used to store templates, wherein each template establishes or serves as a pattern for a web page. A template may include alphanumeric data, static data, and/or a set of variables that, when defined, delineate the source code (such as HTML) that defines a web page. A variable is a placeholder for an undefined value. A variable may be represented by any alphanumeric value, such as a letter. When defined, a variable may be defined by a unique one of a range of values. For example, a variable may be defined any real number, any integer, or any word.

A web page includes a variety of components that may be defined by variables, such as a URL for the web page, and page content for the web page. Page content may include a title for the web page, metadata for the web page, metatags for the web page, and descriptive text for the web page. Page content may also include images, photographs, links to other web pages, source code that displays dynamically fetched data, and source code. Web pages often include metadata in the form of meta tags. Description and keywords meta tags are commonly used to describe the Web page's content. Metatags are used in HTML or XHTML documents to provide structured metadata about a web page. Multiple metatags with different attributes can be used on the same web page. Metatags can be used to specify page description, keywords and any other metadata about a web page.

Source code on a web page may perform one or more of the following actions: pre-populating a search text field with search parameters related to the page content, pre-populating a search text field on another web site with search parameters related to the page content or related to the product/service currently being viewed, displaying products/services that were purchased by other users who purchased the product/service currently being viewed (i.e., “people who bought this also bought . . . ”), displaying reviews by other users about the product/service currently being viewed, displaying data about places or locations wherein the product/service currently being viewed was manufactured or designed, displaying prices or rates for comparable products/services, offers for related or comparable products/services, displaying current inventory or availability levels for the product/service currently being viewed, displaying weather data regarding a location related to the product/service currently being viewed, displaying data about the popularity of the product/service currently being viewed, displaying data about the amounts sold of the product/service currently being viewed, displaying first or second party review scores or other editorial content about the product/service currently being viewed, displaying a deep description of the product/service currently being viewed, such as describing the manufacturing process of the product, or the region or location from which the product/service originated.

In one example, a set of templates is created for the generation of a plurality of entry pages for a web site that sells wine. An example of such a template is shown below:
http://www.website.com/[YearVariable][VineyardVariable][WinetypeVariable]
Shop for [YearVariable] [VineyardVariable] [WinetypeVariable] here.
<meta name=“[YearVariable] [VineyardVariable] [WinetypeVariable]”>
Purchase a bottle of [YearVariable][VineyardVariable][WinetypeVariable] here.

In the example shown above, the first line includes alphanumeric text and variables (in brackets) that, when defined, are used to generate a URL for the web page. The second line includes alphanumeric text and variables that, when defined, are used to generate a title for the web page. The third line includes alphanumeric text and variables that, when defined, are used to generate metadata for the web page. The fourth and last line includes alphanumeric text and variables that, when defined, are used to generate descriptive text for the web page. Thus, as a further example, if the variable were defined as follows—[YearVariable]=1993, [VineyardVariable]=Chateauneuf, [WinetypeVariable]=Red_Wine—then the resulting web page (for the template defined above) would be defined as follows:
http://www.website.com/1993 ChateauneufRed_Wine
Shop for 1993 Chateauneuf Red Wine here.
<meta name=“1993 Chateauneuf Red_Wine”>
Purchase a bottle of 1993 Chateauneuf Red Wine here.

Thus, as can be seen above, a single template comprising multiple variables may be used to produce a plurality of uniquely different web pages since a single variable may take on a variety of values.

Each template, variable, web page, definition or value may be stored in one record in database 104 or may be stored in separate records that may be linked. Also, upon storage in the database 104, each record may be indexed. A database index may be a data structure that improves the speed of data retrieval operations on a database table at the cost of additional writes and storage space to maintain the index data structure. Indexes may be used to quickly locate data without having to search every row in a database table every time a database table is accessed. Indexes can be created using one or more columns of a database table, providing the basis for both rapid random lookups and efficient access of ordered records.

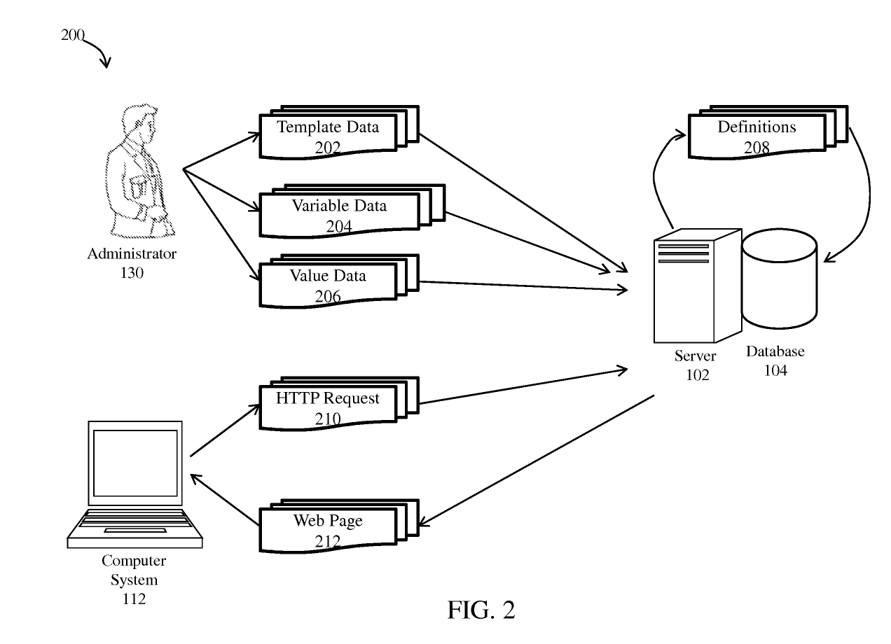

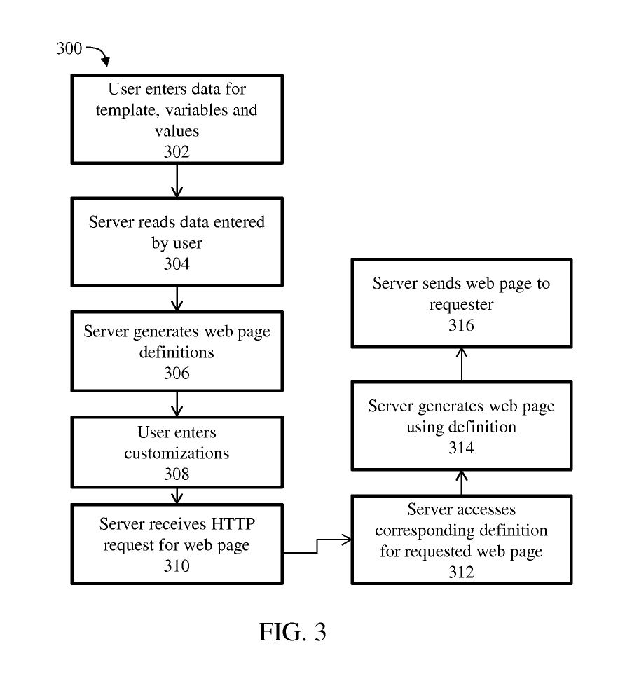

The process for automatically generating a plurality of entry pages for a web site over a communications network will now be described with reference to FIGS. 2 and 3. In step 302, server 102 provides a graphical user interface for the administrator 130, in conjunction with computer system 132, to enter template data 202 for transmission to server 102. Template data 202 refers to data entered by administrator 130 for defining or describing a template. The administrator 130 may enter one or more templates, like the example template shown above. As explained above, a template may include alphanumeric data and a set of variables that, when defined, include computer program code that defines a web page. Also in step 302, server 102 provides a graphical user interface for the administrator 130 to enter variable data 204 and value data 206 for transmission to server 102. The variable data 202 may include a definition of the variables that comprise a template, such as the variable “[VineyardVariable]” shown in the example above. The value data 206 may include a unique value for each of said variables, such as the “Chateauneuf” value shown in the example above, or a range of values for each of said variables.

In one optional step, if the value data 206 includes words in a particular language, such as English, the server 102 may automatically translate said words of the value data 206 into a second language, such as Spanish. As such, the disclosed embodiments allow a user with little or no proficiency in a second language (Spanish) to generate large numbers of entry pages for his web site in said second language. The end result is that a user with little or no proficiency in said second language can use the disclosed embodiments to seamlessly create and edit a database in said second language, including all relationships between data-points within that database.

In step 304, server 102 reads the template data 202, variable data 204 and value data 206 entered by administrator 130. In step 306, server 102 calculates multiple definitions 208 that correspond to said data 202, 204, 206. Each definition corresponds to a single, unique web page. A definition comprises computer program code (such as a script or source code) that defines the data and/or the steps that must be undertaken by server 102 to generate a single, unique web page. PHP code is an example of one embodiment of source code used in a definition. A definition also includes a unique URL for a web page. Each definition 208 may be stored in a unique record database 104 in association with a corresponding unique URL and any other data that identifies the web page defined by said definition (such as any corresponding templates, template data 202, variables, variable data 204, values and value data 206).

Recall that the disclosed embodiments define web pages for later recall in a dynamic manner, without requiring that each web page is created in its entirety and stored on disk. Instead, a definition is stored for each unique web page, wherein the definition consumes less storage than a web page created in its entirety. Thus, the storage of definitions for each web page saves storage space while still allowing for the fast delivery of a unique web page at the time of reception of an HTTP request for said web page.

Also note that in one embodiment, if the value data 206 includes words in a particular language, such as English, the server 102 may automatically translate said words of the value data 206 into a second language, such as Spanish. In this embodiment, in step 304, the server 102 reads the template data 202, variable data 204 and value data 206 entered by administrator 130, the server 102 translates the value data 206 into a second language, and in step 306, server 102 calculates multiple definitions 208 that correspond to said data 202, 204, 206, including calculating definitions that correspond to the second language to which the server 102 translated the value data 206. Each separate definition corresponds to a separate, single, unique web page.

In optional step 308, server 102 provides a graphical user interface to user 130 via the communications network 106, the interface for accepting customization data from the user, wherein said customization data pertains to a particular definition for a web page. For example, the user may desire to customize the particular web page, such as by including a unique or targeted customer offer that is displayed only on said web page. In response to receiving said customization data, the server 102 modifies the particular definition based on said customization data, such that when the web page is generated based on the definition, the web page reflects the customization data. This feature allows for customization of individual web pages.

In step 310, server 102 receives an HTTP request 210, such as from the computer system 112 of third party user 110, or via proxy from customer server 120. An HTTP request includes a unique URL. In response to receiving the HTTP request 210, in step 312, the server 102 accesses in database 102 a record for a definition for a web page that corresponds to the unique URL. Subsequently, in step 314, the server 102 generates the web page 212 based on the definition and in step 316 transmits the web page 212 via the communications network 106 to the user 110.

Recall a definition may be an interpreted language, such as a script. An interpreted language is a programming language for which most of its implementations execute instructions directly, without previously compiling a program into machine-language instructions. The interpreter executes the program directly, translating each statement into a sequence of one or more subroutines already compiled into machine code. In this case, the server 102 interprets the definition so as to execute its instructions.

A definition may alternatively be a compiled language, such as C++. A compiled language is a programming language whose implementations are typically compilers (translators that generate machine code from source code), and not interpreters (step-by-step executors of source code, where no pre-runtime translation takes place). In this case, the server 102 compiles the definition, and then executes the resulting executable, so as to execute its instructions.

In one alternative, in a step before step 310, the server 102 automatically generates a search engine advertising campaign. Search engine advertising is an online advertising service that places advertising copy at the top, bottom, or beside, the list of search results a search engine displays for a particular search query. The choice and placement of the ads is based in part on a proprietary determination of the relevance of the search query to the advertising copy. Search engine advertising may also offer pay-per-click (PPC) services, that is, cost-per-click (CPC) advertising, cost-per-thousand-impressions or cost per mille (CPM) advertising, site-targeted advertising for text, banner, and rich-media ads, and remarketing. Search engine advertising may also offer local, national, and international distribution. Search engine advertising may include advertisements that are short, consisting of a headline, a small number of additional text lines, and a display URL of a small number of characters.

A search engine advertising campaign comprises data used to define when an ad should display (such as keywords, search terms, local, national, and international demographic data) and data used to define the ads to display (copy, ads, text, banner, rich-media ads, etc.). In a step before step 310, the server 102 automatically generates a search engine advertising campaign and stores said campaign in database 104.

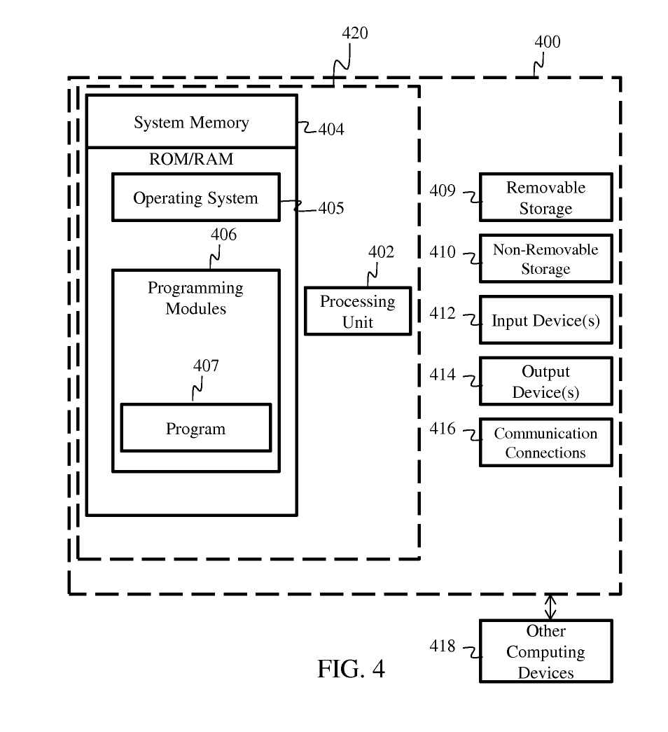

FIG. 4 is a block diagram of a system including an example computing device 400 and other computing devices. Consistent with the embodiments described herein, the aforementioned actions performed by 102, 120, 132, 112 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2-3 above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400′s operation. In one embodiment, programming modules 406 may include, for example, a program module 407, which implements the process of FIG. 3. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

Device 416 may be a network interface device (also known as a network interface card, network adapter, LAN adapter, and by similar terms) is a computer hardware component that connects a computer to a computer network. The network interface device implements the electronic circuitry required to communicate using a specific physical layer and data link layer standard such as Ethernet, Wi-Fi or Token Ring. This provides a base for a full network protocol stack, allowing communication among small groups of computers on the same LAN and large-scale network communications through routable protocols, such as IP.

As stated above, a number of program modules and data files may be stored in system memory 404, including operating system 405. While executing on processing unit 402, programming modules 406 may perform processes including, for example, one or more of the methods shown in FIGS. 2-3 above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the disclosed embodiments have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts related to the process for automatically generating a plurality of entry pages for a web site, it is to be understood that the subject matter defined in the appended claims is not necessarily limited to the specific features or acts described above. Rather, the specific features and acts described above are disclosed as example forms of implementing the claims directed towards the process for automatically generating a plurality of entry pages for a web site.

What is claimed is:

1. A method on a server communicatively coupled to a communications network, the method for automatically generating a plurality of entry pages for a web site, comprising:
a) receiving, via the communications network, at least one template for generating multiple entry pages, wherein the at least one template includes a plurality of variables that define the following for a web page: a URL and page content;
b) receiving, via the communications network, a plurality of values for each of said plurality of variables;
c) for each template of the at least one templates, calculating and storing a definition for each of a plurality of web pages based on said template, wherein a web page is composed of a unique set of values of the plurality of values for the plurality of variables of said template, and wherein the definition includes a unique URL;
d) receiving, via the communications network, an HTTP request for a particular one of the plurality of web pages, wherein the HTTP request includes a unique URL;
e) accessing a definition for a web page of the plurality of web pages that corresponds to the unique URL; and
f) generating the web page based on the definition and transmitting the web page via the communications network.

2. The method of claim 1, wherein the step of receiving, via the communications network, at least one template, further comprises:
providing a graphical user interface to a user via the communications network, the interface for accepting template data from the user.

3. The method of claim 2, wherein the step of receiving, via the communications network, a plurality of values, further comprises:
providing a graphical user interface to the user via the communications network, the interface for accepting value data from the user.

4. The method of claim 3, wherein the step of storing a definition for each of a plurality of web pages further comprises:
storing and indexing a definition for each of a plurality of web pages in a connected database.

5. The method of claim 1, further comprising:
providing a graphical user interface to a user via the communications network, the interface for accepting customization data from the user, wherein said customization data pertains to a particular definition for a web page of the plurality of web pages based on a template of the at least one templates; and
modifying the particular definition based on said customization data, such that when the web page is generated based on the definition, the web page reflects the customization data.

6. The method of claim 1, wherein the step of calculating a definition comprises generating computer program code that produces a web page based on a unique set of values of the plurality of values for the plurality of variables of a template, and wherein the web page includes a unique URL.

7. A computer system communicatively coupled to a communications network, the system for automatically generating a plurality of entry pages for a web site, the computer system comprising:
a database;
a memory;
a network interface device communicatively coupled with the communications network;
a processor communicatively coupled with the memory and the network interface device, the processor configured for:
a) receiving, via the communications network, at least one template for generating multiple entry pages, wherein the at least one template includes a plurality of variables that define the following for a web page: a URL and page content;
b) receiving, via the communications network, a plurality of values for each of said plurality of variables;
c) for each template of the at least one templates, calculating and storing a definition for each of a plurality of web pages based on said template, wherein a web page is composed of a unique set of values of the plurality of values for the plurality of variables of said template, and wherein the definition includes a unique URL;
d) receiving, via the communications network, an HTTP request for a particular one of the plurality of web pages, wherein the HTTP request includes a unique URL;
e) accessing a definition for a web page of the plurality of web pages that corresponds to the unique URL; and
f) generating the web page based on the definition and transmitting the web page via the communications network.

8. The computer system of claim 7, wherein the step of receiving, via the communications network, at least one template, further comprises:
providing a graphical user interface to a user via the communications network, the interface for accepting template data from the user.

9. The computer system of claim 8, wherein the step of receiving, via the communications network, a plurality of values, further comprises:
providing a graphical user interface to the user via the communications network, the interface for accepting value data from the user.

10. The computer system of claim 9, wherein the step of storing a definition for each of a plurality of web pages further comprises:
storing and indexing a definition for each of a plurality of web pages in a connected database.

11. The computer system of claim 7, the processor further configured for:
providing a graphical user interface to a user via the communications network, the interface for accepting customization data from the user, wherein said customization data pertains to a particular definition for a web page of the plurality of web pages based on a template of the at least one templates; and
modifying the particular definition based on said customization data, such that when the web page is generated based on the definition, the web page reflects the customization data.

12. The computer system of claim 7, wherein the step of calculating a definition comprises generating computer program code that produces a web page based on a unique set of values of the plurality of values for the plurality of variables of a template, and wherein the web page includes a unique URL.

13. A method on a server communicatively coupled to a communications network, the method for automatically generating a plurality of entry pages for a web site, comprising:
a) receiving, via the communications network, a template for generating multiple entry pages, wherein the template includes a plurality of variables that define the following for a web page: a URL, page content and metatags;
b) receiving, via the communications network, a plurality of values for each of said plurality of variables;
c) calculating and storing a definition for each of a plurality of web pages based on the template, wherein a web page is composed of a unique set of values of the plurality of values for the plurality of variables of said template, wherein the definition comprises computer program code that produces a web page based on the unique set of values for the plurality of variables of the template, and wherein the definition includes a unique URL;
d) receiving, via the communications network, an HTTP request for a particular one of the plurality of web pages, wherein the HTTP request includes a unique URL;
e) accessing a definition for a web page of the plurality of web pages that corresponds to the unique URL; and
f) generating the web page based on the definition and transmitting the web page via the communications network.

14. The method of claim 13, wherein the step of receiving, via the communications network, at least one template, further comprises:
providing a graphical user interface to a user via the communications network, the interface for accepting template data from the user.

15. The method of claim 14, wherein the step of receiving, via the communications network, a plurality of values, further comprises:
providing a graphical user interface to the user via the communications network, the interface for accepting value data from the user.

16. The method of claim 15, wherein the step of storing a definition for each of a plurality of web pages further comprises:
storing and indexing a definition for each of a plurality of web pages in a connected database.

17. The method of claim 13, further comprising:
providing a graphical user interface to a user via the communications network, the interface for accepting customization data from the user, wherein said customization data pertains to a particular definition for a web page of the plurality of web pages based on a template of the at least one templates; and
modifying the particular definition based on said customization data, such that when the web page is generated based on the definition, the web page reflects the customization data.

18. The method of claim 13, wherein the step of calculating a definition comprises generating a script that produces a web page based on a unique set of values of the plurality of values for the plurality of variables of a template, and wherein the web page includes a unique URL.

19. The method of claim 13, wherein the step of calculating a definition comprises compiling source code to generate an executable that produces a web page based on a unique set of values of the plurality of values for the plurality of variables of a template, and wherein the web page includes a unique URL.
